(19) United States
(12) Patent Application Publication
(10) Pub. No.: US 2008/0201068 A1
(43) Pub. Date: Aug. 21, 2008

(54) Presentation of Sequence Diagrams With Focus Highlighting

(76) Inventors: Michael J. Boyersmith, Banks, OR (US); Barys Dubauski, Portland, OR (US); Cheng-Yee Lin, Tualatin, OR (US)

Correspondence Address: LIEBERMAN & BRANDSDORFER, LLC, 802 STILL CREEK LANE, GAITHERSBURG, MD, 20878, US

(21) Appl. No.: 11/677,129

(22) Filed: Feb. 21, 2007

(51) Int. Cl. G01C 21/00

(52) U.S. Cl. 701/202

(57) ABSTRACT

A method and apparatus are provided to enhance presentation and viewing of a sequence diagram. One or more messages are selected for attachment of a visualization technique to the selected message(s). During presentation of the diagram, the attached visualization technique may be employed to enhance presentation of the diagram and to further explain the details of the associated message(s). The visualization technique focuses the attention of the viewer on the selected portion of the diagram while maintaining the viewer in communication with the non-selected portion of the diagram so as to avoid distracting the viewer to an alternate viewing path.

### BACKGROUND OF THE INVENTION

1. Technical Field

This invention relates to the use of sequence diagram for object modeling. More specifically, the invention relates to enhancing the use of such diagrams with viewing tools and techniques.

2. Description of the Prior Art

Unified Modeling Language (UML) is a general purpose modeling language that includes a standard graphical notation used to create an abstract model of a system. UML is used to model software, business processes, and systems engineering, as well as represent organization structures. A sequence diagram is an interaction diagram written in UML. It is a diagram that emphasizes the flow of control and data among the things in the system being modeled. The sequence diagram shows different processes or objects that live simultaneously and messages exchanged between processes and/or object in the order in which they occur. A typical sequence diagram has two axes, a horizontal axis and vertical axis. All objects in the diagram are lined up along one axis, and relative time is represented on the other axis. Accordingly, the sequence diagram shows the interaction between objects over a period of time.

Sequence diagrams may be used to document an organization's current affairs, as well as to communicate requirements for a future system implementation. The sequence diagram defines event sequences that result in some desired outcome. The focus of the sequence diagram is primarily on the order in which messages occur and secondarily on the content of the messages. In one embodiment, the sequence diagram will communicate what messages are sent between a system's processes or objects as well as the order in which they occur. The diagram conveys this information along the horizontal and vertical axis. The vertical axis shows the time sequences of messages and calls as they occur, and the horizontal axis shows the process of object instances where the messages are sent. In one embodiment, the vertical axis shows the time sequences from top to bottom, and the horizontal axis shows the occurrence of process or object instances from left to right. A lifeline in the sequence diagram represents either roles or object instances that participate in the sequence being modeled. When drawing a sequence diagram, lifeline notation elements are placed across the top of the diagram. In one embodiment, a lifeline is drawn as a box with a dashed line descending from the center of the bottom edge with the name of the lifeline placed inside the box. Not all lifelines represent named objects. In one embodiment, a lifeline can be used to represent an anonymous or unnamed instance. As noted above, messages are sent between processes or objects in the sequence diagram. In one embodiment, the first message of a sequence diagram starts at the top and subsequent messages are added to the diagram slightly lower than the previous message. The message is shown as a horizontal line with an arrow at one end. A message name identifying the message is commonly placed above the arrowed line. The message that is being sent to the receiving process or object represents an operation/method that the receiving object's class implements. In one embodiment, the diagram may include return messages represented as a dotted horizontal line with an arrowhead pointing to the originating lifeline. The use of return message depends on the level of detail and/or abstraction being modeled.

FIG. 1 is a prior art illustration of a sequence diagram (100). As shown in FIG. 1, the presentation illustrates interactions that are involved in the process of purchasing an automobile. There is a vertical axis (102) and a horizontal axis (104). The objects in the diagram are shown at the top along the horizontal axis (104). The objects shown herein include the buyer (106), the car expert (108), the agent (110), the finance officer (112), and the credit agency (114). Each of the objects shown has a lifeline. For example, the buyer (106) has lifeline (116), the car expert (108) has lifeline (118), the agent (110) has lifeline (120), the finance officer (112) has lifeline (122), and the credit agency (114) has lifeline (124). As noted above, in a sequence diagram messages are illustrated between objects in sequential order. In relation to purchasing a vehicle, the first message (130) pertains to the buyer (106) speaking to a car expert (108) to solicit information for the buyer, as shown in a second message (132), regarding a make and model of a vehicle that will suit the needs of the buyer (106). In one embodiment, the buyer (106) may speak (134) to another car expert (108) to solicit information (136) on the same vehicle or another vehicle. When the buyer (106) has finished soliciting information and has made a decision on a vehicle to purchase, the buyer (106) will communicate with a sales agent (138). If the buyer (106) requires financing to purchase the vehicle, the buyer (106) will complete a credit application and the sales agent (110) will submit the application (140) to a finance officer (112). Following receipt of the credit application, the finance officer (112) submits the credit application to a credit agency (142). The financing component of the process of purchasing a vehicle may continue with respect to lending agencies with communication between one or more lending agencies, the finance officer (112), or the buyer (106).

The flow of a sequence diagram can be complex due to the amount of information that may be present in the diagram. It is therefore desirable to focus attention on a select portion of the diagram. One prior art solution for focusing on a select portion of the diagram is to insert a secondary viewer at a select portion of the diagram. The secondary viewer, such as Microsoft PowerPoint, enables a user of the system to focus on a particular idea within a select portion of the diagram. However, the secondary viewer removes the focus of the audience from the diagram to a secondary medium and thereby distracts the user away from the subject sequence diagram. Accordingly, there is a need for a drill-down solution that enables a presenter to focus on a selected portion of the sequence diagram while allowing the user to maintain the focus of the audience on the entire sequence diagram.

### SUMMARY OF THE INVENTION

This invention comprises a method and system for navigating a sequence diagram for enhanced display and viewing thereof.

In one aspect of the invention, a method is provided for navigating data. Steps of a process are represented in a sequence diagram having a plurality of objects with at least one interaction between two objects. An area of the navigated diagram is selected for review. The area of the diagram is in the form of either an individual interaction identified in the diagram, or a range of two or more interactions identified in the diagram. A visualization technique to the selected area is toggled to enhance presentation of the elements represented in the selected area of the sequence diagram. The visualization technique supports focusing of attention of a view of the sequence diagram on the selected area of the sequence diagram while maintaining a view of the non-selected area(s) of the diagram.

In another aspect of the invention, a computer system is provided with a processor in communication with storage media, and a visual display. A sequence diagram is stored in computer readable format in the storage media and is viewed on the visual display. The diagram represents steps of a process. The diagram illustrates at least two objects and at least one interaction between the objects. A selection manager is provided to support selection of an area of the diagram for review. The selected area is either an individual interaction identified in the diagram or a range of two or more interactions identified in the diagram. A visualization manager is provided to toggle employment of a visualization technique for a selected area of the diagram to enhance presentation of elements represented in the selected area. The visualization technique supports focus of attention on the selected area of the sequence diagram, and at the same time maintains a view of the non-selected area(s) of the diagram.

In yet another aspect of the invention, an article of manufacture is provided with a computer readable medium having computer-readable instructions stored thereon executable by a processor. The computer-readable instructions include instructions to navigate data represented in a sequence diagram. The sequence diagram has a plurality of objects and at least one interaction between two objects. In addition, instructions are provided to select an area of the navigated diagram for review and to employ a visualization technique. The area to be investigated is either an individual interaction identified in the diagram, or a range of two or more interactions identified in the diagram. The instructions for employing a visualization technique to the selected area enhance presentation of the elements represented in the selected area of the sequence diagram. The visualization technique supports focus of attention on a view of said sequence diagram on the selected area, and at the same time maintains a view of the non-selected area(s) of the diagram.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a prior art block diagram of a sequence diagram.

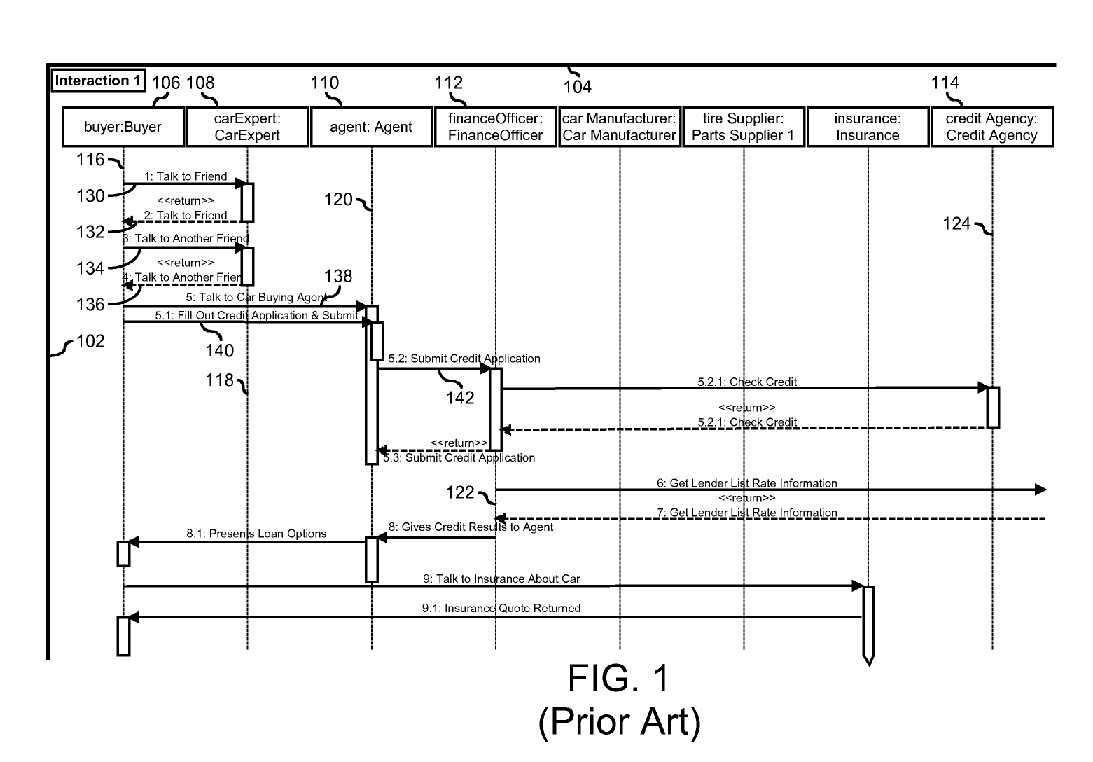

FIG. 2 is a flow chart illustrating steps of embedding visualization techniques with messages in the sequence diagram.

FIG. 3 is a block diagram of a sequence diagram with an embedded visualization technique according to the preferred embodiment of this invention, and is suggested for printing on the first page of the issued patent.

FIG. 4 is a block diagram of a computer system with a tool for communication with a sequence diagram.

### DESCRIPTION OF THE PREFERRED EMBODIMENT

### Overview

Sequence diagrams are tools used to convey complex scheduling between multiple objects and the communication of messages there between. To facilitate presentation and viewing of the diagram, visualization techniques may be embedded into one or more messages in the tool. The visualization techniques enable a presenter of the diagram to maintain the focus of attention of the audience on the diagram as a whole, while supporting a detailed presentation pertaining to one or more messages in the diagram.

### Technical Details

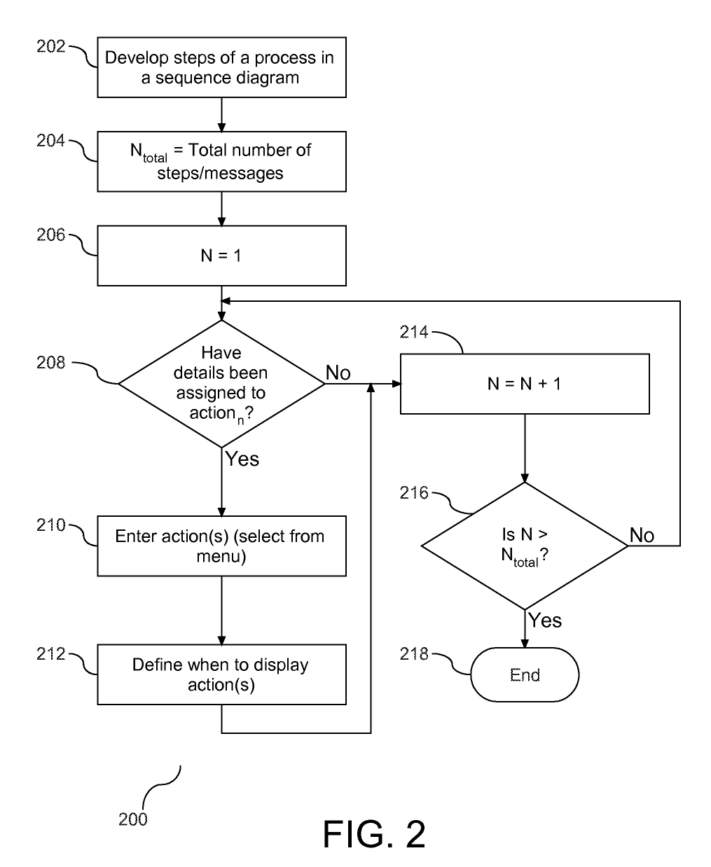

FIG. 2 is a flow chart (200) illustrating a process for embedding display enhancements into a sequence diagram. In one embodiment, the enhancements are embedded in the diagram during creation of the sequence diagram. Similarly, in another embodiment, the enhancements may be embedded in select areas of the diagram after its creation. The following steps illustrate a process for developing steps of a process in the form of a sequence diagram (202). In one embodiment, the development at step (202) may include embedding enhancements into the sequence diagram after creation of the initial diagram. The variable N_{Total} represents the total number of messages in the sequence diagram (204). Messages in the sequence diagram are numbered in sequential order. The variable N represents each message in the sequence diagram and is initially assigned to the first message (206). Following step (206), a determination is made as to whether a person modifying the sequence diagram wants to assign details to the message N under consideration (208). If the response to the determination at step (208) is positive, actions associated with message N are entered (210), followed by defining when the actions should be displayed (212). In one embodiment, a visualization technique may have been applied to the select message at an earlier time, and the process of the above-outlined steps supports modification of the prior applied technique. Accordingly, the steps outlined above are an example for selecting an area of the sequence diagram for review and optionally embedding visualization techniques.

In one embodiment, a developer of the diagram may be presented with a menu of available actions to embed with selected interaction(s). For example, a wizard may be provided to allow the user to assign details to the element in the diagram selected for assignment of detail(s). In one embodiment, the wizard might define when the assigned details will be displayed, such as, when the sequence diagram element gains focus for the first time, every time the sequence diagram element gains focus, and/or only show the details of the event if the sequence diagram element has focus. Additionally, in one embodiment, the menu may enable the developer to attach a video clip, a graph, etc. In one embodiment, an editing tool facilitates the process of entering the action(s) and associated instructions. Following step (212) or a negative response to the determination at step (208), the variable N is incremented (214). Thereafter, it is determined whether the variable N is greater than N_{Total} (216). A negative response in step (216) causes the process to return to step (208) to determine whether or not to assign details to the message N under consideration. A positive response in step (216) ends the process of embedding actions in the messages of the sequence diagram (218). Following creation of the sequence diagram actions and associated display instructions may be embedded and attached, respectively, to individual messages of the diagram. Once the sequence diagram is created and actions are embedded with one or more messages, the diagram may be used and or presented to an audience.

In one embodiment, the selected visualization technique is a color filter. This technique enables different colors and shades of color to be applied to different portions of the diagram. For example, a first color enhancement may be applied to one or more selected interaction(s) and a second color enhancement may be applied to one or more non-selected interaction(s). In one embodiment, a previously viewed area of the diagram may be presented in a third color enhancement, wherein the third color enhancement is different from or the same as the first or second color enhancements. For example, the application of color enhancements may enable interactions of the diagram previously viewed and interactions of the diagram not yet viewed to appear to be faded out in comparison to the selected interaction(s). More specifically, display of information in a selected area may be in a detailed view, and display of information related to a non-selected area may be faded or otherwise constricted. In one embodiment, the faded color of the previously viewed interactions may be a different faded color than the interactions waiting to be viewed. Similarly, in one embodiment, the color enhancements may be shades of gray.

In one embodiment, the visualization technique embedded within the sequence diagram is a detailed view for one or more selected interaction(s). Examples of detailed views include, but are not limited to, bullet points, graphics, streaming media, static pictures, animations, movies, slide, multi-media, sounds, events, etc. A presenter may select one or more of the detailed views to be embedded with one or more selected interactions. In one embodiment, the select interaction(s) may include more than one detailed view option and at such time as the diagram is presented a pointer tool may be employed to select one of the detailed view options from the list available.

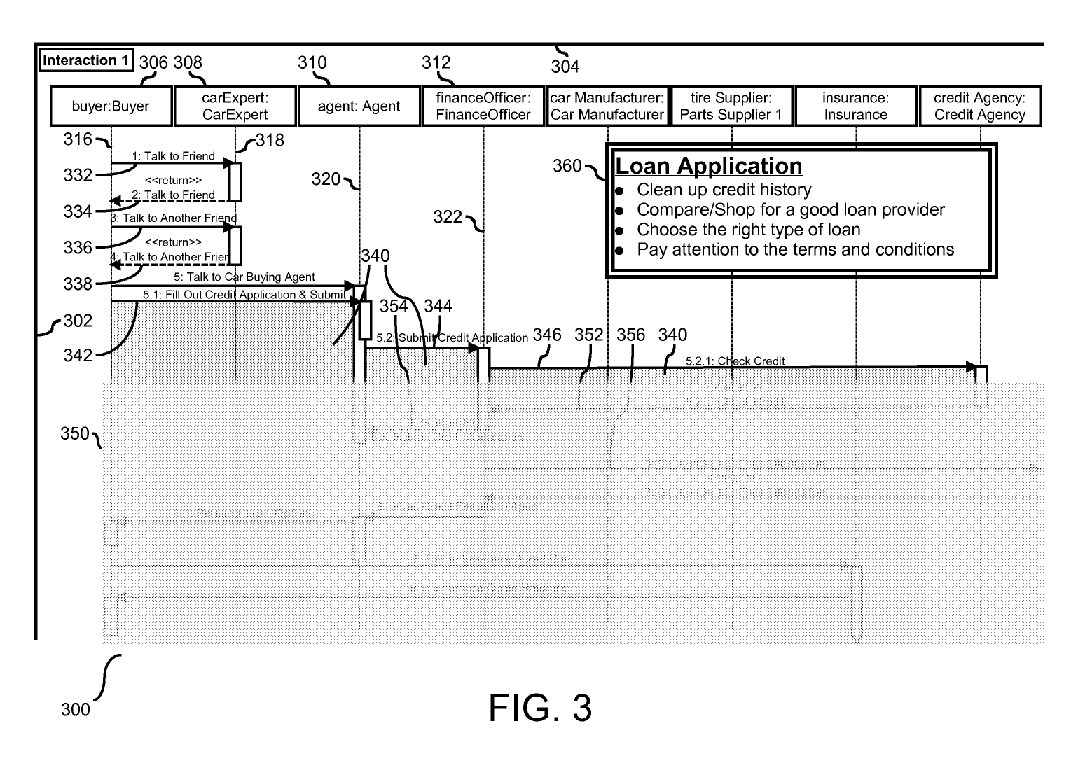

FIG. 3 is a block diagram (300) of a sample sequence diagram with an embedded visualization technique. As shown, the diagram illustrates interactions that are involved in the process of purchasing an automobile. There is a vertical axis (302) and a horizontal axis (304). The objects in the diagram are shown at the top along the horizontal axis (304). The objects shown herein include the buyer (306), the car expert (308), the agent (310), and the finance officer (312). Each of the objects shown has a lifeline. For example the buyer (306) has lifeline (316), the car expert (308) has lifeline (318), the agent (310) has lifeline (320), and the finance officer (312) has lifeline (322). As noted above, sequence diagram messages are illustrated between objects in sequential order. Messages (332), (334), (336), and (338) have been previously viewed and are presented in a first shade of gray (not shown). In one embodiment, the first shade of gray may be transparent or white. As shown herein, the color enhancements are shades of gray. In one embodiment, the color enhancements may be in the form of different colors. Messages (342), (344), and (346) are in the process of being presented and are shown in a second shade of gray (340). Similarly, messages (352), (354), and (356) have not been viewed or presented and are shown in a third shade of gray (350). The purpose of the three different shades of gray (330), (340), and (350) is to draw attention to specific interactions in the sequence diagram. Furthermore, as shown herein, a detailed view (360) is available at message (344). In one embodiment, a symbol (not shown) is shown at a message that has a detailed view option available and the presenter determines the granularity of the presentation by placing an input device in the vicinity of the symbol to activate a menu to enable the presenter to select one or more detailed views for demonstration to an audience. Similarly, in one embodiment, the detailed view at message (344) is automatically shown when a presenter views this message. Accordingly, one or more interactions in the sequence diagram may be embedded with a color enhancements and/or visualization techniques to facilitate demonstration of the sequence diagram.

In one embodiment, the invention is implemented in software, which includes but is not limited to firmware, resident software, microcode, etc. The invention can take the form of a computer software product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

Embodiments within the scope of the present invention also include articles of manufacture comprising program storage means having encoded therein program code. Such program storage means can be any available media which can be accessed by a general purpose or special purpose computer. By way of example, and not limitation, such program storage means can include RAM, ROM, EEPROM, CD-ROM, or other optical disk storage, magnetic disk storage or other magnetic storage devices, or any other medium which can be used to store the desired program code means and which can be accessed by a general purpose or special purpose computer. Combinations of the above should also be included in the scope of the program storage means.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, random access memory (RAM), read-only memory (ROM), a rigid magnetic disk, and an optical disk. Current examples of optical disks include compact disk B read only (CD-ROM), compact disk B read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

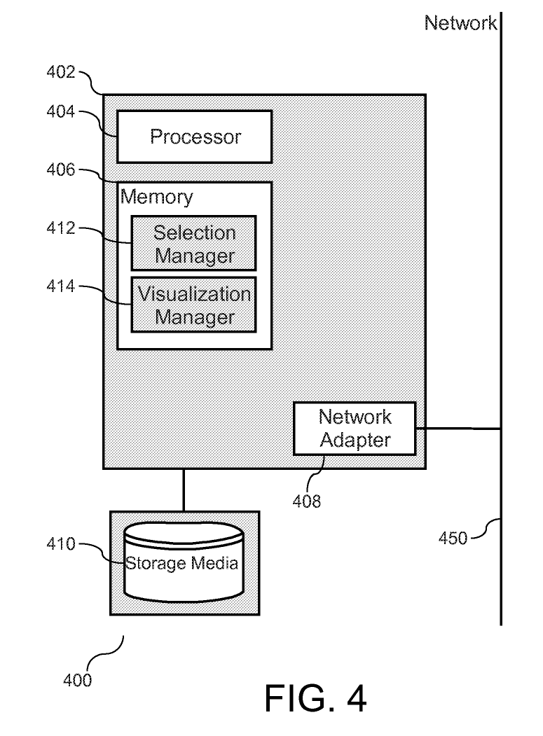

In one embodiment, a selection manager and a visualization manager are provided in software or hardware. With respect to the software implementation, the managers may include, but are not limited to, firmware, resident software, microcode, etc. The software implementation can take the form of a computer program product accessible from a computer-useable or computer-readable medium providing program code for use by or in connection with a computer or any instruction execution system. FIG. 4 is a block diagram (400) illustrating placement of the navigation tool in a computer system. The illustration shows a computing device (402) with a processor (404) and memory (406). As shown, the computing device (402) may communicate across a network (450) through a network adapter (408). The sequence diagram is stored in storage media (410) in communication with the computing device (402). In one embodiment, the storage media (410) may be remote data storage (not shown) that is accessible through communications across the network (450). A selection manager (412) and a visualization manager (414) are shown residing in memory (404) of the computer device (402). The selection manager (412) may implement instructions to select a specific sequence diagram in local or remote storage. Following selection of the sequence diagram, instructions may be implemented to navigate the diagram and to select one or more messages to attach navigational enhancements. In one embodiment, the selection manager (412) embeds two or more instructions to one or more messages together with a menu to support selection by the visualization manager (414) of one or more of the instructions. Accordingly, the selection embeds techniques for viewing and the visualization manager toggles the selection of embedded techniques of the selected message(s) in the diagram to facilitate presentation thereof to an audience.

For the purposes of this description, a computer-useable or computer-readable medium can be any apparatus that can contain, store, communicate, propagate, or transport the program for use by or in connection with the instruction execution system, apparatus, or device.

As shown, network adapters may also be coupled to the system to enable the data processing system to become coupled to other data processing systems or remote printers or storage devices through intervening private or public networks. Modems, wireless and Ethernet adapters are just a few of the currently available types of network adapters.

### Advantages Over the Prior Art

A sequence diagram may include one or more visualization techniques and features to be embedded within messages of the diagram. The messages enable the presenter to explain the featured message(s) in detail while enabling the audience viewing the diagram to maintain their focus on the diagram. A diagram developer or a presenter of the diagram embeds visualization techniques and attaches the embedded techniques to one or more messages in the diagram.

### Alternative Embodiments

It will be appreciated that, although specific embodiments of the invention have been described herein for purposes of illustration, various modifications may be made without departing from the spirit and scope of the invention. In particular, it has been explained in detail that the developer of the sequence diagram can embed visualization techniques to facilitate presentation of the diagram to an audience. Prior to presentation, the person presenting the diagram can select to turn off the detailed events placed into the program. This feature enables a global command to affect presentation of the diagram. Similarly, a global command may be provided to exhibit all of the embedded visualization techniques upon presentation. In one embodiment, a user interface is provided as a communication tool between the developer and the presenter. The user interface facilitates embedding visualization techniques in association with one or more messages. Similarly, the user interface or an equivalent input device may be used to dictate the frequency in which the embedded visualization techniques will be viewed by an audience. For example, the frequency of display may include when the selected message(s) in sequence diagram gain focus for the first time, every time the selected message(s) gains focus, and manual activation of the selected message(s). Accordingly, the scope of protection of this invention is limited only by the following claims and their equivalents.

We claim:

1. A method for navigating data, comprising:
representing steps of a process in a sequence diagram having a plurality of objects with at least one interaction between two objects;
selecting an area of said diagram for review, wherein said area is selected from the group consisting of: an individual interaction identified in said diagram, and a range of two or more interactions identified in said diagram;
embedding a visualization technique to said selected area to enhance presentation of said elements represented in said selected area of said sequence diagram, wherein said visualization technique supports focusing attention of a view of said sequence diagram on said selected area and maintaining a view of a non-selected area of said diagram.

2. The method of claim 1, wherein the step of selecting an area for investigation includes employing an input device to communicate with said sequence diagram.

3. The method of claim 1, wherein said visualization technique includes filtering said selected area with a color enhancing technique including presenting said selected area with a first color enhancement, presenting a non-selected area with a second color enhancement, and presenting a previously visited area in a third color enhancement, wherein said second and third color enhancements are selected from the group consisting of the same color, shades of gray, and a different color.

4. The method of claim 3, wherein said non-selected areas of said sequence diagram includes previously viewed areas and areas waiting to be viewed.

5. The method of claim 1, wherein said visualization technique includes presentation of information selected from the group consisting of: display of information related to said selected area in a detailed view, and constricting display of information related to a non-selected area.

6. The method of claim 5, wherein said detailed view includes media events selected from the group consisting of static pictures, animations, movies, mini-slides, sound events, and combinations thereof.

7. The method of claim 5, further comprising customizing said visualization technique to dictate display of said detailed view, wherein occurrence of said display is selected from a group consisting of: when a select element in said sequence diagram receives an initial focus, every time said select element in said sequence diagram gains focus; and only when a manually request for a detailed view of said select element is received.

8. A computer system comprising:
a processor in communication with storage media, and a visual display;
a sequence diagram, stored in computer readable format in said storage media and viewed on said visual display, to represent steps of a process, said diagram having at least two objects and at least one interaction between said objects;
a selection manager to support selection of an area of said diagram for review, wherein said area is selected from the group consisting of an individual interaction identified in said diagram, and a range of two or more interactions identified in said diagram; and
a visualization manager to embed a visualization technique for a selected area of said diagram to enhance presentation of elements represented in said selected area, wherein said visualization technique supports focus of attention on said selected area of said sequence diagram and a view of a non-selected area of said diagram.

9. The system of claim 8, further comprising an input device in communication with said processor and said visual display to communicate with said sequence diagram.

10. The system of claim 8, further comprising a filter in communication with said visualization manager, wherein said filter applies a first color enhancement to a selected area of said diagram, a second color enhancement to a non-selected area of said diagram, and a third color enhancement to a previously viewed area of said diagram, wherein said second and third color enhancement are selected from the group consisting of: a same color, shades of gray, and a different color.

11. The system of claim 10, wherein said non-selected area of said sequence diagram includes all previously viewed area and area waiting to be viewed.

12. The system of claim 8, wherein said selection manager enables display of information related to said selected area selected from the group consisting of:
display of information in a detailed view, and constricting display of information related to a non-selected area.

13. The system of claim 12, wherein said detailed view includes media events selected from the group consisting of static pictures, animations, movies, mini-slides, sound events, and combinations thereof.

14. The system of claim 12, further comprising a customization manager to dictate display of said detailed view, wherein occurrence of said display is selected from the group consisting of: when a select element in said sequence diagram receives an initial focus, every time said select element in said sequence diagram gains focus, and only when a manual request for a detailed view of said select element is received.

15. An article of manufacture comprising:
a computer readable medium having computer-readable instructions stored thereon executable by a processor, comprising:
instructions to navigate data represented in a sequence diagram, said sequence diagram having a plurality of objects with at least one interaction between two objects;
instructions to select an area of said navigated diagram for review, wherein said area is selected from the group consisting of: an individual interaction identified in said diagram, and a range of two or more interactions identified in said diagram;
instructions to embed a visualization technique to said selected area to enhance presentation of said elements represented in said selected area of said sequence diagram, wherein said visualization technique supports focusing attention of a view of said sequence diagram on said selected area while maintaining a view of a non-selected area of said diagram.

16. The article of claim 15, wherein the instructions to select an area for investigation includes employment of an input device to communicate with said sequence diagram.

17. The article of claim 15, wherein said visualization technique includes a filter for application of a color enhancing technique to a selected area, wherein said application of said technique includes presenting said selected area with a first color enhancement, presenting a non-selected area with a second color enhancement, and presenting a previously visited area in a third color enhancement, wherein said second and third color enhancements are selected from the group consisting of: the same color, shades of gray, and a different color.

18. The article of claim 15, wherein the instructions to embed a visualization technique includes presentation of information selected from the group consisting of: display of information related to said selected area in a detailed view, and constricting display of information related to a non-selected area.

19. The article of claim 18, wherein said detailed view includes media events selected from the group consisting of static pictures, animations, movies, mini-slides, sound events, and combinations thereof.

20. The article of claim 18, further comprising instructions in the medium for customizing said visualization technique to dictate display of said detailed view, wherein occurrence of said display is selected from a group consisting of: when a select element in said sequence diagram receives an initial focus, every time said select element in said sequence diagram gains focus; and only when a manually request for a detailed view of said select element is received.
